(19) United States
(12) Patent Application Publication
(10) Pub. No.: US 2013/0153756 A1
(43) Pub. Date: Jun. 20, 2013

(54) OBJECT DETECTING DEVICE AND INFORMATION ACQUIRING DEVICE

(71) Applicant: Sanyo Electric Co., Ltd., Osaka (JP)

(72) Inventors: Katsumi UMEDA, Osaka (JP); Takaaki MORIMOTO, Osaka (JP)

(73) Assignee: Sanyo Electric Co., Ltd., Osaka (JP)

(21) Appl. No.: 13/731,535

(22) Filed: Dec. 31, 2012

Related U.S. Application Data
(63) Continuation of application No. PCT/JP2011/061316, filed on May 17, 2011.

(30) Foreign Application Priority Data
Jul. 7, 2010 (JP) 2010-155239
Apr. 12, 2011 (JP) 2011-088606

(51) Int. Cl. G01V 8/12

(52) U.S. Cl. CPC G01V 8/12
USPC 250/225; 250/216

(57) ABSTRACT

An information acquiring device is provided with a laser light source, a diffractive optical element which is disposed in such a direction as to be away from an optical axis of the laser light source, a photodetector which is disposed to face the diffractive optical element with respect to the optical axis, and an optical path separating portion which guides laser light emitted from the laser light source to the diffractive optical element, and guides the laser light reflected on the diffractive optical element to the photodetector. The diffractive optical element irradiates a target area with the laser light having a predetermined pattern. The photodetector receives a part of the laser light diffracted and reflected on the diffractive optical element.

This application claims priority under 35 U.S.C. Section 119 of Japanese Patent Application No. 2010-155239 filed on Jul. 7, 2010, entitled “OBJECT DETECTING DEVICE AND INFORMATION ACQUIRING DEVICE” and No. 2011-88606 filed on Apr. 12, 2011, entitled “OBJECT DETECTING DEVICE AND INFORMATION ACQUIRING DEVICE.” The disclosure of the above applications is incorporated herein by reference.

### BACKGROUND OF THE INVENTION

1. Field of the Invention

The present invention relates to an object detecting device for detecting an object in a target area, based on a state of reflected light when light is projected onto the target area, and an information acquiring device incorporated with the object detecting device.

2. Disclosure of Related Art

Conventionally, there has been developed an object detecting device using light in various fields. An object detecting device incorporated with a so-called distance image sensor is operable to detect not only a two-dimensional image on a two-dimensional plane but also a depthwise shape or a movement of an object to be detected. In such an object detecting device, light in a predetermined wavelength band is projected from a laser light source or an LED (Light Emitting Diode) onto a target area, and light reflected on the target area is received by a light receiving element such as a CMOS image sensor. Various types of sensors are known as the distance image sensor.

A distance image sensor which is configured to irradiate a target area with laser light having a predetermined dot pattern is operable to receive reflected light of laser light from the target area at each dot position by a light receiving element. The distance image sensor is operable to detect a distance to each portion (each dot position on an object to be detected) of the object to be detected, based on the light receiving position of laser light on the light receiving element corresponding to each dot position, using a triangulation method (see e.g. pp. 1279-1280, the 19th Annual Conference Proceedings (Sep. 18th-20th, 2001) by the Robotics Society of Japan).

In the object detecting device thus constructed, a diffractive optical element is used for generating laser light having a dot pattern. A predetermined diffraction pattern is formed on the diffractive optical element by e.g. hologram, and laser light is diffracted by the diffraction pattern. A target area is irradiated with laser light having a predetermined dot pattern by such a diffractive function.

When laser light has such a dot pattern, the laser light is diffused in a relatively large area within a target area. However, as the diffraction pattern of the diffractive optical element is deteriorated by e.g. a change with time, the diffractive function with respect to laser light also changes. As a result, laser light transmitted through the diffractive optical element without diffusion may be concentratedly irradiated in a small area. In such a case, it is desirable to stop emitting laser light.

It is possible to detect deterioration of a diffractive optical element by e.g. monitoring a state of diffracted light. In this case, a monitor optical system may be disposed on downstream side of the diffractive optical element with respect to the propagating direction of laser light. In the above arrangement, however, since a laser light source, a collimator lens, a diffractive optical element, and a monitor optical system are linearly arranged, the size of the device increases in the arrangement direction of these parts.

### SUMMARY OF THE INVENTION

A first aspect according to the invention is directed to an information acquiring device for acquiring information on a target area using light. The information acquiring device according to the first aspect includes a laser light source; a diffractive optical element which is disposed in such a direction as to be away from an optical axis of the laser light source; a photodetector which is disposed to face the diffractive optical element with respect to the optical axis; and an optical path separating portion which guides laser light emitted from the laser light source to the diffractive optical element, and guides the laser light reflected on the diffractive optical element to the photodetector. The diffractive optical element irradiates the target area with the laser light having a predetermined pattern. The photodetector receives a part of the laser light diffracted and reflected on the diffractive optical element.

A second aspect according to the invention is directed to an object detecting device. The object detecting device according to the second aspect has the information acquiring device according to the first aspect.

### BRIEF DESCRIPTION OF THE DRAWINGS

These and other objects, and novel features of the present invention will become more apparent upon reading the following detailed description of the embodiment along with the accompanying drawings.

FIG. 1 is a diagram showing an arrangement of an object detecting device embodying the invention.

FIG. 2 is a diagram showing an arrangement of an information acquiring device and an information processing device in the embodiment.

FIGS. 3A and 3B are diagrams respectively showing an irradiation state of laser light onto a target area, and a light receiving state of laser light on an image sensor in the embodiment.

FIGS. 4A through 4C are diagrams showing an arrangement of a projection optical system and a light receiving optical system in the embodiment of the invention.

FIGS. 5A and 5B are diagrams showing an operation of a diffractive optical element and an arrangement of a photodetector in the embodiment.

FIG. 6A is a flowchart showing a control of a laser light source, and FIG. 6B is a diagram showing a change of PD signal with time in the embodiment.

FIGS. 7A and 7B are diagrams showing a projection optical system for verifying an effect of the embodiment.

FIG. 8 is a diagram showing a measurement result for verifying the effect of the embodiment.

FIGS. 9A and 9B are diagrams showing an arrangement of a photodetector in a modification.

FIGS. 10A and 10B are diagrams showing optical systems in a light emitting unit and in a light receiving unit in other modifications.

The drawings are provided mainly for describing the present invention, and do not limit the scope of the present invention.

### DESCRIPTION OF PREFERRED EMBODIMENTS

In the following, an embodiment of the invention is described referring to the drawings. In the embodiment, a PBS 113 and a quarter wave plate 114 correspond to an “optical path separating portion” in the claims. A DOE 116 corresponds to a “diffractive optical element” in the claims. A PD 117 corresponds to a “photodetector” in the claims. A half mirror 122 corresponds to a “non-polarized beam splitter” in the claims. A laser controller 21a corresponds to a “control portion” in the claims. The description regarding the correspondence between the claims and the embodiment is merely an example, and the claims are not limited by the description of the embodiment.

In the following, an embodiment of the invention is described referring to the drawings. In the embodiment, an information acquiring device configured to irradiate a target area with laser light having a predetermined dot pattern is described as an example.

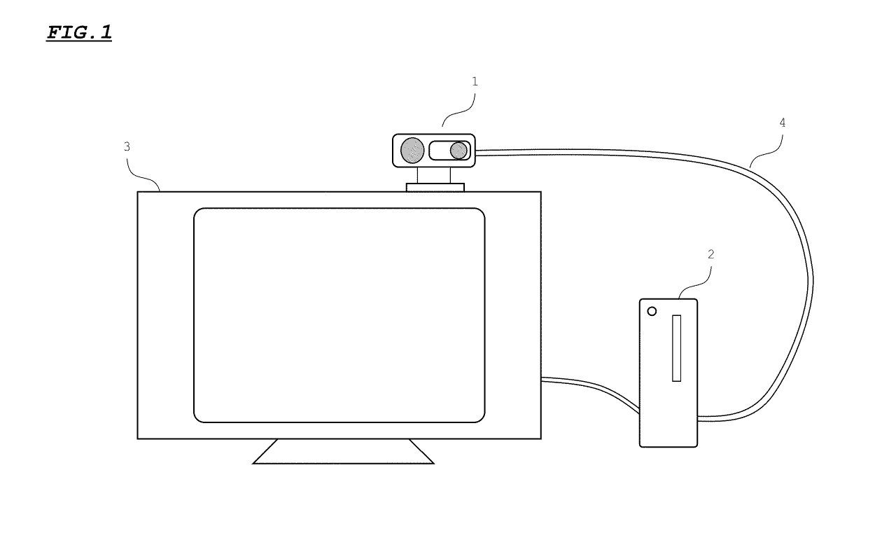

Firstly, a schematic arrangement of an object detecting device according to the first embodiment is described. As shown in FIG. 1, the object detecting device is provided with an information acquiring device 1, and an information processing device 2. A TV 3 is controlled by a signal from the information processing device 2.

The information acquiring device 1 projects infrared light to the entirety of a target area, and receives reflected light from the target area by a CMOS image sensor to thereby acquire a distance (hereinafter, called as “three-dimensional distance information”) to each part of an object in the target area. The acquired three-dimensional distance information is transmitted to the information processing device 2 through a cable 4.

The information processing device 2 is e.g. a controller for controlling a TV or a game machine, or a personal computer. The information processing device 2 detects an object in a target area based on three-dimensional distance information received from the information acquiring device 1, and controls the TV 3 based on a detection result.

For instance, the information processing device 2 detects a person based on received three-dimensional distance information, and detects a motion of the person based on a change in the three-dimensional distance information. For instance, in the case where the information processing device 2 is a controller for controlling a TV, the information processing device 2 is installed with an application program operable to detect a gesture of a user based on received three-dimensional distance information, and output a control signal to the TV 3 in accordance with the detected gesture. In this case, the user is allowed to control the TV 3 to execute a predetermined function such as switching the channel or turning up/down the volume by performing a certain gesture while watching the TV 3.

Further, for instance, in the case where the information processing device 2 is a game machine, the information processing device 2 is installed with an application program operable to detect a motion of a user based on received three-dimensional distance information, and operate a character on a TV screen in accordance with the detected motion to change the match status of a game. In this case, the user is allowed to play the game as if the user himself or herself is the character on the TV screen by performing a certain action while watching the TV 3.

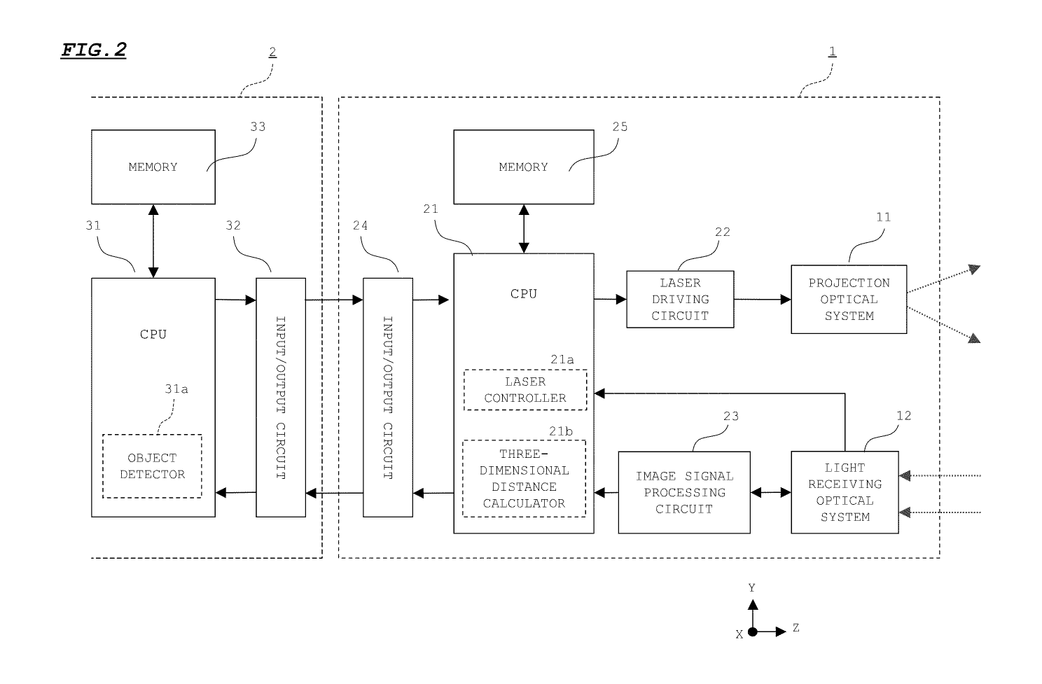

FIG. 2 is a diagram showing an arrangement of the information acquiring device 1 and the information processing device 2.

The information acquiring device 1 is provided with a projection optical system 11 and a light receiving optical system 12, which constitute an optical section. In addition to the above, the information acquiring device 1 is provided with a CPU (Central Processing Unit) 21, a laser driving circuit 22, an image signal processing circuit 23, an input/output circuit 24, and a memory 25, which constitute a circuit section.

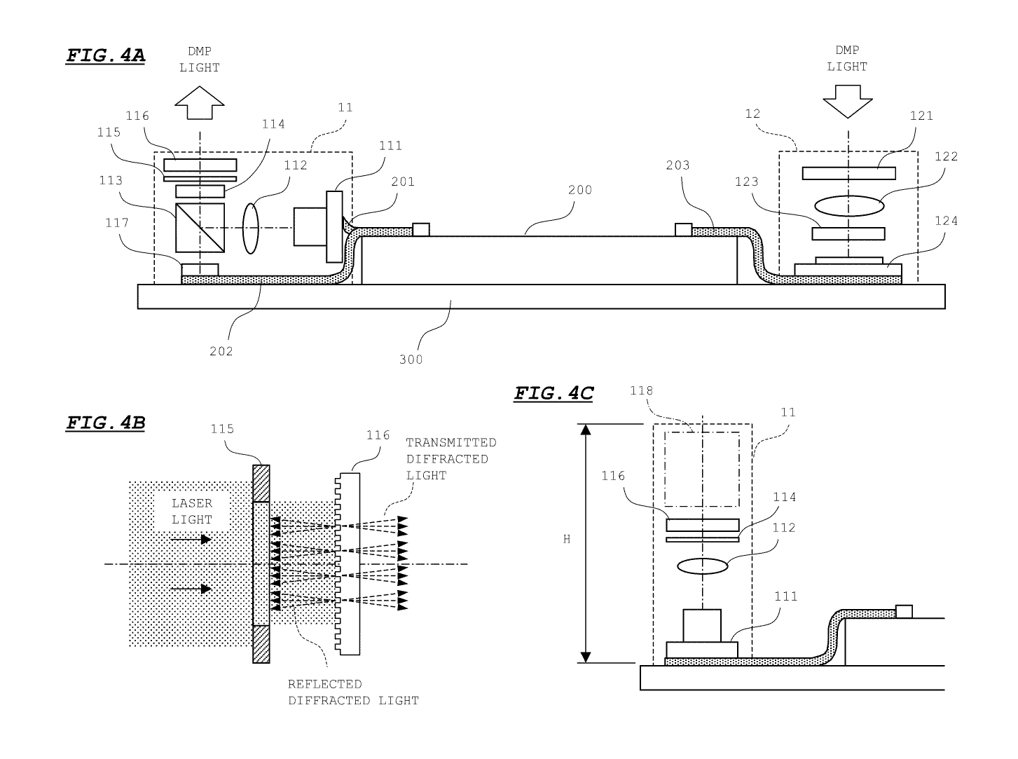

The projection optical system 11 irradiates a target area with laser light having a dot matrix pattern. The light receiving optical system 12 receives laser light reflected on the target area. The arrangement of the projection optical system 11 and the light receiving optical system 12 will be described later referring to FIG. 4A.

The CPU 21 controls the parts of the information acquiring device 1 in accordance with a control program stored in the memory 25. By the control program, the CPU 21 has a function of a laser controller 21a for controlling the laser light source 111 (to be described later) in the projection optical system 11, and a three-dimensional distance calculator 21b for generating three-dimensional distance information.

The laser driving circuit 22 drives the laser light source 111 (to be described later) in accordance with a control signal from the CPU 21. The image signal processing circuit 23 controls the CMOS image sensor 124 (to be described later) in the light receiving optical system 12 to successively read signals (electric charges) from the pixels, which have been generated in the CMOS image sensor 124, line by line. Then, the image signal processing circuit 23 outputs the read signals successively to the CPU 21.

The CPU 21 calculates a distance from the information acquiring device 1 to each portion of an object to be detected, by a processing to be implemented by the three-dimensional distance calculator 21b, based on the signals (image signals) to be supplied from the image signal processing circuit 23. The input/output circuit 24 controls data communications with the information processing device 2.

The information processing device 2 is provided with a CPU 31, an input/output circuit 32, and a memory 33. The information processing device 2 is provided with e.g. an arrangement for communicating with the TV 3, or a drive device for reading information stored in an external memory such as a CD-ROM and installing the information in the memory 33, in addition to the arrangement shown in FIG. 2. The arrangements of the peripheral circuits are not shown in FIG. 2 to simplify the description.

The CPU 31 controls each of the parts of the information processing device 2 in accordance with a control program (application program) stored in the memory 33. By the control program, the CPU 31 has a function of an object detector 31a for detecting an object in an image. The control program is e.g. read from a CD-ROM by an unillustrated drive device, and is installed in the memory 33.

For instance, in the case where the control program is a game program, the object detector 31a detects a person and a motion thereof in an image based on three-dimensional distance information supplied from the information acquiring device 1. Then, the information processing device 2 causes the control program to execute a processing for operating a character on a TV screen in accordance with the detected motion.

Further, in the case where the control program is a program for controlling a function of the TV 3, the object detector 31a detects a person and a motion (gesture) thereof in the image based on three-dimensional distance information supplied from the information acquiring device 1. Then, the information processing device 2 causes the control program to execute a processing for controlling a predetermined function (such as switching the channel or adjusting the volume) of the TV 3 in accordance with the detected motion (gesture).

The input/output circuit 32 controls data communication with the information acquiring device 1.

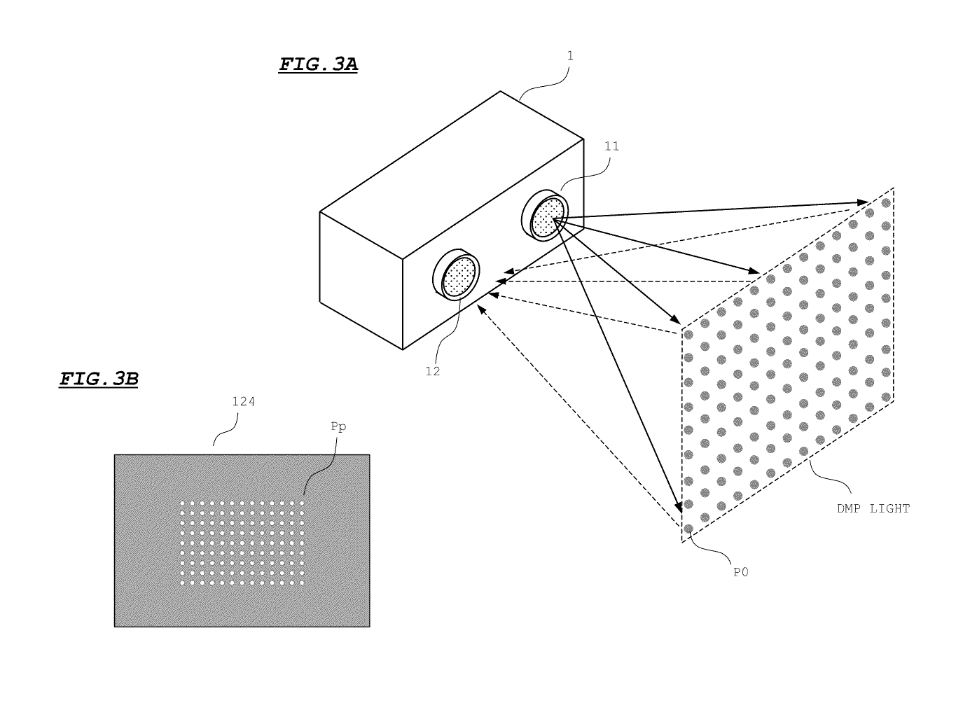

FIG. 3A is a diagram schematically showing an irradiation state of laser light onto a target area. FIG. 3B is a diagram schematically showing a light receiving state of laser light on the CMOS image sensor 124. To simplify the description, FIG. 3B shows a light receiving state in the case where a flat plane (screen) is disposed on a target area.

As shown in FIG. 3A, laser light (hereinafter, the entirety of laser light having a dot matrix pattern is called as “DMP light”) having a dot matrix pattern is irradiated from the projection optical system 11 onto a target area. FIG. 3A shows a light flux cross section of DMP light by a broken-line frame. Each dot in DMP light schematically shows a region where the intensity of laser light is locally enhanced by a diffractive action of the diffractive optical element in the projection optical system 11. The regions where the intensity of laser light is locally enhanced appear in the light flux of DMP light in accordance with a predetermined dot matrix pattern.

In the case where a flat plane (screen) is disposed in a target area, light of DMP light reflected on the flat plane at each dot position is distributed on the CMOS image sensor 124, as shown in FIG. 3B. For instance, light at a dot position P0 on a target area corresponds to light at a dot position Pp on the CMOS image sensor 124.

The three-dimensional distance calculator 21b is operable to detect to which position on the CMOS image sensor 124, the light corresponding to each dot is entered, for detecting a distance to each portion (each dot position on a dot matrix pattern) of an object to be detected, based on the light receiving position, by a triangulation method. The details of the above detection technique is disclosed in e.g. pp. 1279-1280, the 19th Annual Conference Proceedings (Sep. 18th-20th, 2001) by the Robotics Society of Japan.

FIG. 4A is a diagram showing an arrangement of the projection optical system 11 and the light receiving optical system 12.

The projection optical system 11 is provided with a laser light source 111, a collimator lens 112, a polarized beam splitter (PBS) 113, a quarter wave plate 114, an aperture 115, a diffractive optical element (DOE) 116, and a photodetector (PD) 117. The light receiving optical system 12 is provided with an aperture 121, an imaging lens 122, a filter 123, and a CMOS image sensor 124.

The laser light source 111 outputs laser light in a narrow wavelength band of or about 830 nm. The collimator lens 112 converts the laser light emitted from the laser light source 111 into parallel light. The PBS 113 reflects laser light entered from the collimator lens 112 side. The position of the laser light source 111 is adjusted in such a manner that laser light is emitted as S-polarized light with respect to a polarization plane of the PBS 113.

The quarter wave plate 114 converts laser light entered from the PBS 113 side into circularly polarized light, and converts laser light (reflected diffracted light on the DOE 116) entered from the aperture 115 side into light in a polarization direction orthogonal to the polarization direction of laser light to be entered from the PBS 113 side. By performing the above operation, laser light (reflected diffracted light on the DOE 116) entered from the aperture 115 side is converted into P-polarized light with respect to the PBS 113, and transmitted through the PBS 113.

The aperture 115 adjusts a light flux cross section of laser light into a predetermined shape (in the embodiment, a circular shape). The DOE 116 has a diffraction pattern on an incident surface thereof. Laser light entered to the DOE 116 through the aperture 115 is converted into laser light having a dot matrix pattern by a diffractive function of the diffraction pattern, and is irradiated onto a target area.

As shown in FIG. 4B, diffracted light on the DOE 116 includes transmitted light and reflected light. Out of the transmitted light and the reflected light, the transmitted light (transmitted diffracted light) is projected onto a target area as DMP light as described above. Laser light (reflected diffracted light) that has been diffracted and reflected on the DOE 116 is entered to the quarter wave plate 114 through the aperture 115. Thereafter, the reflected diffracted light is converted into linearly polarized light by the quarter wave plate 114, and transmitted through the PBS 113 as described above.

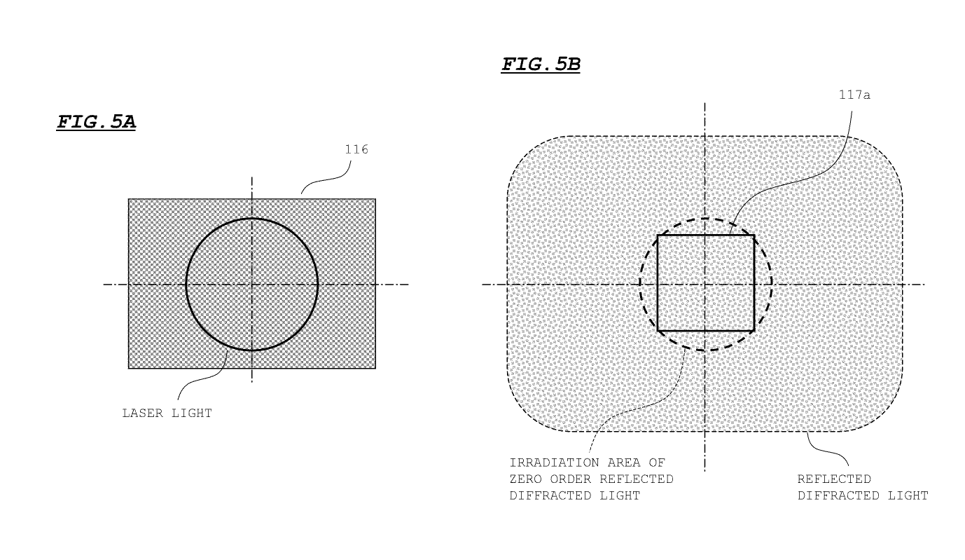

The PD 117 receives reflected diffracted light that has been transmitted through the PBS 113. The arrangement of the PD 117 will be described later referring to FIGS. 5A and 5B.

Laser light reflected on the target area is entered to the imaging lens 122 through the aperture 121. The aperture 121 limits external light in accordance with the F-number of the imaging lens 122. The imaging lens 122 condenses the light entered through the aperture 121 on the CMOS image sensor 124.

The filter 123 is a band-pass filter which transmits light in a wavelength band including the emission wavelength (about 830 nm) of the laser light source 111, and cuts light in a wavelength band other than the above. The CMOS image sensor 124 receives light condensed on the imaging lens 122, and outputs a signal (electric charge) in accordance with a received light amount to the image signal processing circuit 23 pixel by pixel. In this example, the CMOS image sensor 124 is configured in such a manner that the output speed of signals to be outputted from the CMOS image sensor 124 is set high so that a signal (electric charge) at each pixel can be outputted to the image signal processing circuit 23 with high response from a light receiving timing at each pixel.

The projection optical system 11 and the light receiving optical system 12 are installed on a base member 300. A circuit board 200 is provided on the base member 300. Wirings (flexible substrates) 201 through 203 are respectively connected from the circuit board 200 to the laser light source 111, the PD 117, and the CMOS image sensor 124. A circuit portion of the information acquiring device 1 such as the CPU 21 and the laser driving circuit 22 shown in FIG. 2 is mounted on the circuit board 200.

FIGS. 5A and 5B are diagrams for describing a method for arranging the PD 117. FIG. 5A schematically shows an incident state of laser light with respect to the DOE 116, and FIG. 5B schematically shows an irradiation state of reflected diffracted light on the DOE 116 with respect to the PD 117.

As described above, laser light is entered to the DOE 116 as parallel light. Accordingly, out of the reflected diffracted light on the DOE 116, zero order reflected diffracted light which has been reflected on the DOE 116 without diffraction also returns to the aperture 115 substantially as parallel light. Thus, in the case where laser light is entered to the DOE 116 in the manner as shown in FIG. 5A, zero order reflected diffracted light is emitted toward the PD 117 substantially with the same size as the spot size of a laser beam shown in FIG. 5A. Further, first-order and higher-order reflected diffracted light that has been diffracted on the DOE 116 is also emitted toward the PD 117. Since first-order and higher-order reflected diffracted light spreads by diffraction, as shown in FIG. 5B, the first-order and higher-order reflected diffracted light is irradiated in a large area including the irradiation area of zero order reflected diffracted light. It should be noted that the first-order and higher-order reflected diffracted light is also irradiated onto the irradiation area of zero order reflected diffracted light.

In this embodiment, as shown in FIG. 5B, a light receiving surface 117a of the PD 117 is disposed at such a position that the light receiving surface 117a is substantially included in the irradiation area of zero order reflected diffracted light. In this arrangement, the PD 117 is operable to receive zero order reflected diffracted light, and first-order and higher-order reflected diffracted light. Since first-order and higher-order reflected diffracted light is diffused in a large area, the amount of first-order and higher-order reflected diffracted light to be received by the PD 117 is relatively small. Accordingly, the amount of zero order reflected diffracted light to be received by the PD 117 is significantly larger than the amount of first-order and higher-order reflected diffracted light to be received by the PD 117 by several orders. Consequently, an output signal from the PD 117 is greatly affected by zero order reflected diffracted light.

In the case where the DOE 116 is normally operated, a predetermined amount of zero order reflected diffracted light is irradiated onto the light receiving surface 117a. On the other hand, in the case where the DOE 116 is deteriorated by e.g. a change with time, the amount of zero order reflected diffracted light to be irradiated onto the light receiving surface 117a increases or decreases, resulting from a change in diffractive function, and an output signal from the PD 117 increases or decreases accordingly. Thus, it is possible to detect deterioration of the DOE 116 by monitoring an output from the PD 117.

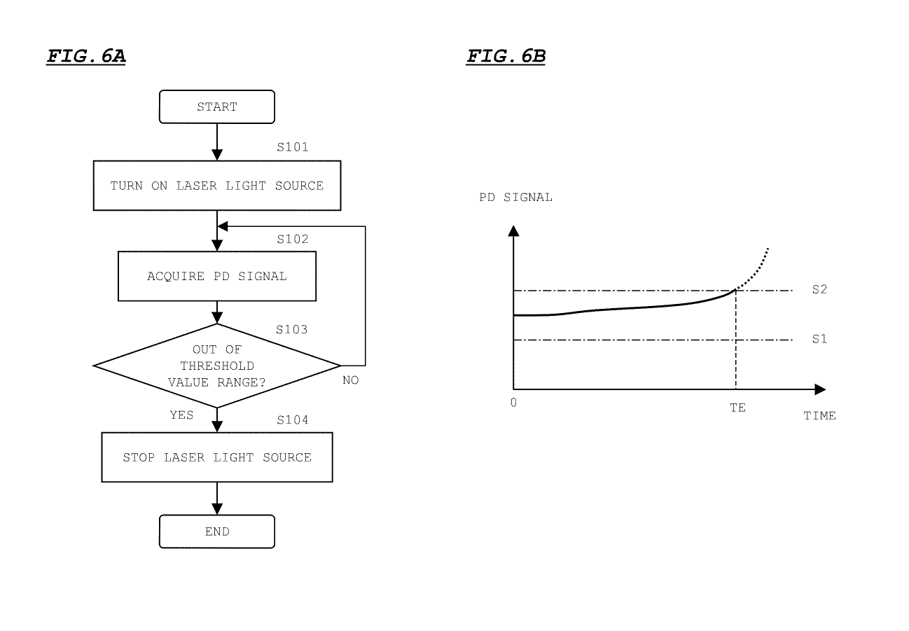

FIG. 6A is a flowchart showing a control operation to be performed by the laser controller 21a, based on an output signal from the PD 117. In this embodiment, as shown in FIG. 6B, threshold values S1 and S2 are set for monitoring an output signal (PD signal) from the PD 117. Deterioration (anomaly) of the DOE 116 is determined by deviation of the PD signal from the range between the threshold value S1 and the threshold value S2.

Referring to FIG. 6A, after the laser light source 111 is turned on (S101), a PD signal is sampled (S102), and it is determined whether the value of the sampled PD signal lies in a range between the threshold value S1 and the threshold value S2 (S103). In the case where the value of the PD signal lies in the range between the threshold value S1 and the threshold value S2, the laser light source 111 is continued to be turned on, and Steps S102 and S103 are repeated.

Thereafter, in the case where the PD signal is out of the range between the threshold value S1 and the threshold value S2 (S103: YES), it is determined that the DOE 116 is deteriorated (is in an anomaly state), and the laser light source 111 is caused to stop emitting laser light. By performing the above operation, irradiation of DMP light onto the target area is stopped. For instance, in the example shown in FIG. 6B, at a timing TE, the PD signal is out of the range between the threshold value S1 and the threshold value S2, and accordingly, irradiation of DMP light onto the target area is stopped. By performing the above operation, for instance, it is possible to prevent concentration of the power of laser light on a part of the target area. This is advantageous in securing safe use of the device.

As described above, in the embodiment, as shown in FIG. 4A, the projection optical system 11 is configured in such a manner that the optical path of laser light emitted from the laser light source 111 is bent. This is advantageous in reducing the size of the projection optical system 11 in the height direction (direction perpendicular to the installation plane of the base member 300), and miniaturizing the projection optical system 11.

For instance, in the case where a monitor optical system 118 for detecting deterioration of a DOE 116 is disposed on the output surface side of the DOE 116, as shown in the comparative example of FIG. 4C, since the monitor optical system 118 is linearly arranged together with a laser light source 111, a collimator lens 112, an aperture 115, and the DOE 116 with respect to the height direction, the height of the projection optical system becomes significantly large. In this arrangement, the monitor optical system 118 is configured to receive a part of transmitted diffracted light that has been transmitted through the DOE 116.

In contrast, in this embodiment, as shown in FIG. 4A, the optical path of laser light emitted from the laser light source 111 is bent. This is advantageous in reducing the size of the projection optical system 11 in the height direction (direction perpendicular to the installation plane of the base member 300), and miniaturizing the projection optical system 11.

Further, in this embodiment, as described above referring to FIGS. 6A and 6B, once deterioration (anomaly) of the DOE 116 is detected based on a PD signal, the laser light source 111 is caused to stop emitting laser light. This is advantageous in preventing irradiation of laser light in an unstable condition onto a target area, and enhancing safe use of the information acquiring device.

The inventors of the present application verified that deterioration (anomaly) of the DOE 116 is detectable based on a PD signal by conducting actual measurement. In the following, the verification is described.

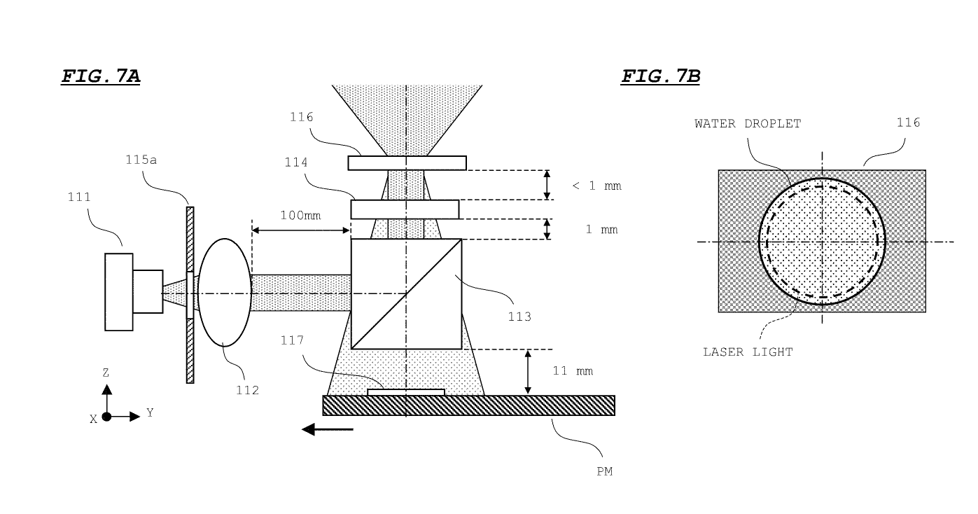

FIG. 7A is a diagram showing an arrangement of a projection optical system used in the verification. The projection optical system shown in FIG. 7A is different from the projection optical system 11 shown in FIG. 4A in the position of the aperture. Specifically, whereas in the projection optical system 11 shown in FIG. 4A, the aperture 115 is disposed between the quarter wave plate 114 and the DOE 116, in the projection optical system shown in FIG. 7A, an aperture 115a is disposed between a laser light source 111 and a collimator lens 112. Further, a PD 117 is disposed in a power meter PM. The power meter PM measures a power of laser light received on the PD 117. The other arrangement of the projection optical system shown in FIG. 7A is substantially the same as the corresponding arrangement of the projection optical system 11 shown in FIG. 4A.

The aperture 115a shapes oval-shaped laser light emitted from the laser light source 111 into laser light of a substantially circular shape. In the measurement, the gap between the collimator lens 112 and a PBS 113 was set to 100 mm, the gap between the PBS 113 and a quarter wave plate 114 was set to 1 mm, the gap between the quarter wave plate 114 and a DOE 116 was set to a value smaller than 1 mm, and the gap between the PBS 113 and the power meter PM was set to 11 mm. The model 47784-K manufactured by Edmund Optics Inc. was used as the PBS 113, the model 46412-K manufactured by Edmund Optics Inc. was used as the quarter wave plate 114, and the model Q8230 manufactured by Advantest Corporation was used as the power meter PM.

The laser light source 111 has an emission wavelength of 830 nm, and is disposed to emit laser light in Y-axis direction in FIG. 7A. The optical axis of the laser light source 111 and the optical axis of the collimator lens 112 are aligned with each other, and the collimator lens 112 is disposed at such a position as to substantially convert laser light into parallel light. The PBS 113 is disposed at such a position that laser light from the collimator lens 112 is entered as S-polarized light, and that the entered laser light is reflected in Z-axis direction. The quarter wave plate 114 and the DOE 116 are respectively disposed at such positions that each incident surface thereof extends perpendicular to Z-axis. The PD 117 is disposed at such a position that the light receiving surface thereof extends perpendicular to Z-axis.

The DOE 116 has a diffraction pattern on the output surface thereof for uniformly distributing twenty-five thousand dots in a rectangular area of 1.9 m in vertical direction and 2.3 m in horizontal direction on an imaginary plane defined at a forward position (plus Z-axis direction) of the DOE 116 by 2 m. The diffraction pattern is constituted of a multi-step diffractive structure.

At the measurement, the projection optical system shown in FIG. 7A was operated in such a manner that laser light having an emission power of 200 mW was emitted from the laser light source 111, and an intensity of received light was measured by the power meter PM. In the measurement, firstly, the PD 117 was disposed at such a position (where the offset value was set to zero) that the center of the PD 117 was aligned with the center of laser light (reflected diffracted light) that has been diffracted and reflected on the DOE 116, and a light receiving power of the PD 117 was measured by emitting laser light of the aforementioned power in the above state. Further, a light receiving power of the PD 117 was measured at each position by shifting the PD 117 from the offset zero position leftward (minus Y-axis direction) in FIG. 7A to respective displacement positions away from the offset zero position by 1 mm, 2 mm, 3 mm, 4 mm, 5 mm, 6 mm, 7 mm, 8 mm, 9 mm, and 10 mm, while continuing to emit laser light of the aforementioned power from the laser light source 111.

Then, water was allowed to drop onto the laser light output position on the output surface of the DOE 116 in such a manner that a water droplet of a size slightly larger than the spot size of laser light was adhered to the output surface. In this state, laser light of the aforementioned power was emitted, and a light receiving power of the PD 117 was measured at each position i.e. at the offset positions of 0 mm, 1 mm, 2 mm, 3 mm, 4 mm, 5 mm, 6 mm, 7 mm, 8 mm, 9 mm, and 10 mm in the same manner as described above.

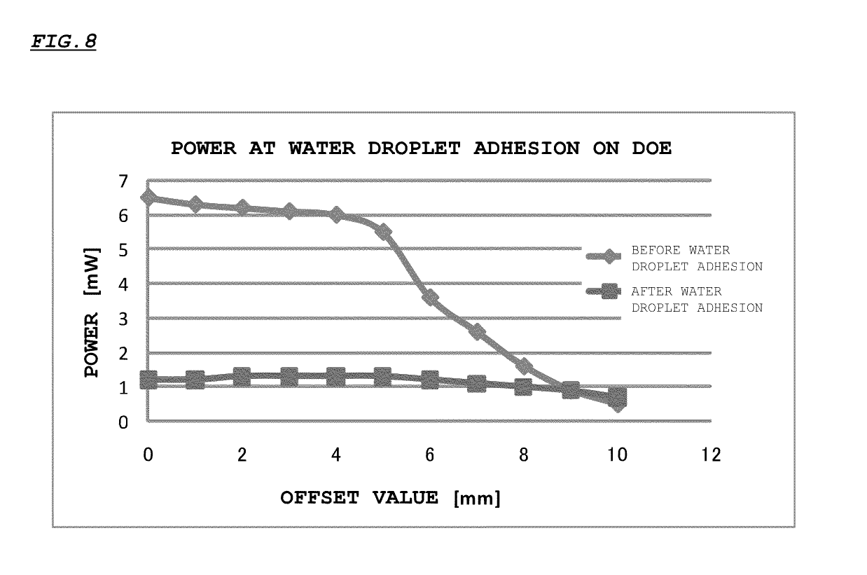

FIG. 8 is a diagram showing a measurement result. In FIG. 8, the graph “before water droplet adhesion” shows a measurement result obtained in the case where the aforementioned measurement was performed before a water droplet was adhered, and the graph “after water droplet adhesion” shows a measurement result obtained in the case where the aforementioned measurement was performed in a state that a water droplet was adhered.

Firstly, referring to the graph “before water droplet adhesion”, it is clear that the light receiving power of the PD 117 moderately decreases as the offset value of the PD 117 increases, and that the light receiving power of the PD 117 sharply lowers when the offset value exceeds around 5 mm. In this example, it is presumed that the position where the offset value is 5 mm corresponds to a position where an end of the light receiving surface of the PD 117 in minus Y-axis direction reaches a boundary of the irradiation area of reflected diffracted light. Accordingly, it is clear that reflected diffracted light spreads in left and right directions by a certain range with respect to the center of reflected diffracted light, on a plane including the light receiving surface of the PD 117. It is presumed that such a spreading of reflected diffracted light reflects spreading of laser light directing toward a target area through the DOE 116.

Next, referring to the graph “after water droplet adhesion”, the light receiving power of the PD 117 is substantially kept around 1 mW, regardless of the offset value of the PD 117. Further, it is clear that the light receiving power of the PD 117 is less likely to come close to zero, even if the offset value exceeds 10 mm and more. The above result presumably shows that the irradiation area of reflected diffracted light significantly increases, on a plane including the light receiving surface of the PD 117, as compared with the measurement result obtained “before water droplet adhesion”. Thus, it is presumed that laser light directing toward the target area through the DOE 116 also spreads in a significantly large area, as compared with the measurement result obtained “before water droplet adhesion”.

Comparing between the two graphs shown in FIG. 8, it is clear that the light receiving power of the PD 117 greatly changes in the case where a water droplet adheres to the output surface of the DOE 116, and an anomaly is generated on the diffraction pattern formed on the output surface of the DOE 116. Accordingly, disposing the PD 117 at a position near the center of reflected diffracted light (within a region corresponding to the irradiation area of diffracted reflected light) in a normal state of the DOE 116 is advantageous in detecting an anomaly of the DOE 116 based on a detection signal (PD signal) from the PD 117, and detecting an anomaly of projected laser light resulting from the anomaly of the DOE 116.

Accordingly, as shown in FIG. 6A, controlling the laser light source 111 to stop emitting laser light in response to detection of deterioration (anomaly) of the DOE 116 based on a PD signal is advantageous in preventing irradiation of laser light in an unstable condition onto a target area, and enhancing safe use of the information acquiring device.

In the aforementioned measurement, the value of a detection signal (PD signal) from the PD 117 obtained “after water droplet adhesion” is smaller than the value of a PD signal obtained “before water droplet adhesion” by several orders. However, it is presumed that the value of a PD signal to be obtained in an anomaly state may be considerably larger than the value of a PD signal to be obtained in a normal state, depending on the types of deterioration (anomaly) generated in the DOE 116. In such a case, laser light directing toward a target area from the DOE 116 may be concentratedly irradiated in a small area. Such an anomaly can be detected, as shown in FIG. 6B, by setting the threshold value S2 higher than a detection signal to be obtained in a normal state, in addition to setting the threshold value S1 lower than a PD signal to be obtained in a normal state, and by determining that an anomaly has occurred in the case where the PD signal does not lie in the range between the threshold values S1 and S2. Thus, the control shown in FIG. 6A is advantageous in accurately detecting an anomaly of the DOE 116, which may occur in a variety of conditions.

The embodiment of the invention has been described as above. The invention is not limited to the foregoing embodiment, and the embodiment of the invention may be changed or modified in various ways other than the above.

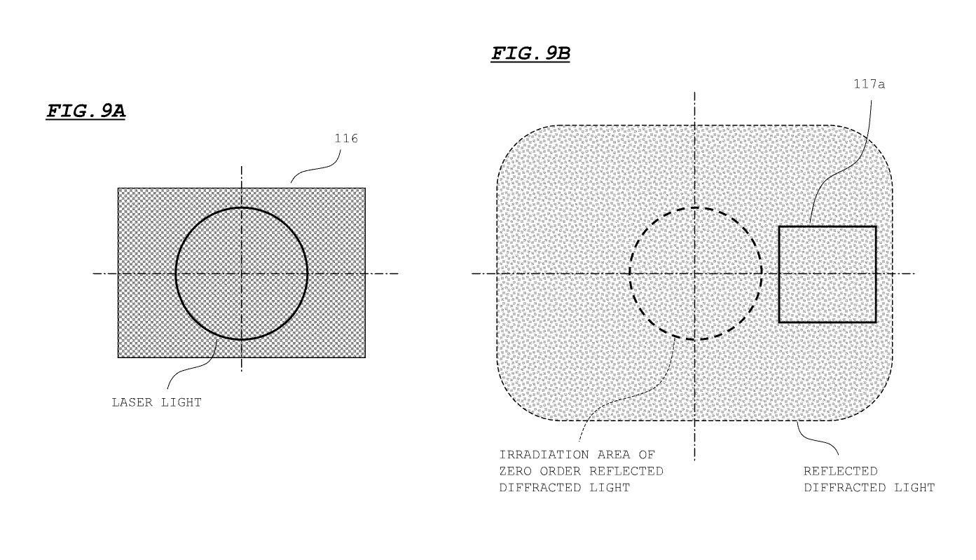

For instance, in the embodiment, as shown in FIG. 5B, the light receiving surface 117a of the PD 117 is disposed in the irradiation area of zero order reflected diffracted light. Alternatively, as shown in FIG. 9B, the light receiving surface 117a may be disposed in the irradiation area of reflected diffracted light excluding the irradiation area of zero order reflected diffracted light. In the modification, as far as the DOE 116 is normally operated, a predetermined amount of first-order and higher-order reflected diffracted light is irradiated onto the light receiving surface 117a. Further, in the case where the DOE 116 is deteriorated by e.g. a change with time, the amount of first-order and higher-order reflected diffracted light to be irradiated onto the light receiving surface 117a increases or decreases resulting from a change in diffractive function, and an output signal from the PD 117 increases or decreases accordingly. In such a case, it is possible to detect deterioration of the DOE 116 by monitoring an output from the PD 117 in the same manner as described above referring to FIG. 5B. Alternatively, the light receiving surface 117a may be disposed at such a position that the light receiving surface 117a partly overlaps the irradiation area of zero order reflected diffracted light.

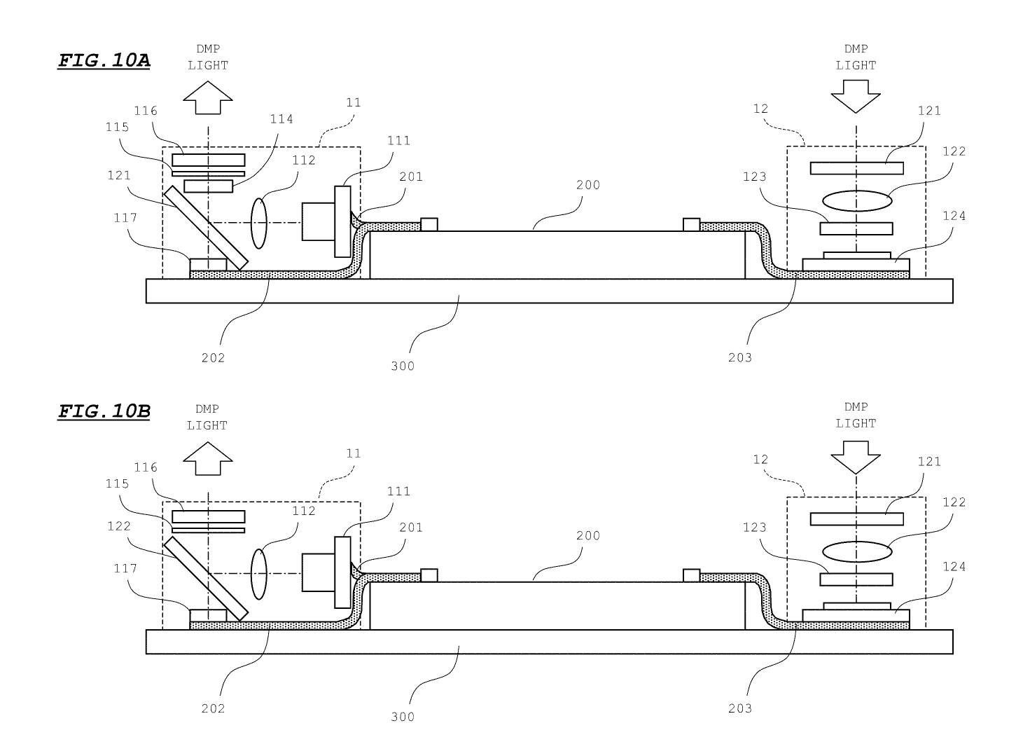

Further, in the embodiment, as shown in FIG. 4A, a cubic-shaped PBS 113 is used. Alternatively, a plate-shaped PBS 121 may be used as shown in FIG. 10A. In the modification, the PBS 121 is disposed at such a position that a polarization plane of the PBS 121 is inclined by 45 degrees with respect to the installation plane of the base member 300.

Further alternatively, as shown in FIG. 10B, a half mirror 122 may be used in place of the PBS 113. In the modification, the half mirror 122 is disposed at such a position that the incident surface thereof is inclined by 45 degrees with respect to the installation plane of the base member 300. In the modification, since a half of laser light to be emitted from the laser light source 111 is transmitted through the half mirror 122, the amount of laser light to be irradiated onto a target area lowers, as compared with the embodiment. However, since the quarter wave plate 114 is not necessary, the arrangement of the modification is simplified, as compared with the embodiment. Further alternatively, it is possible to use another non-polarized beam splitter, in which the ratio between transmittance and reflectance is other than 1:1, in place of the half mirror.

Further, in the embodiment, the CMOS image sensor 124 is used as a light receiving element. Alternatively, a CCD image sensor may be used. Further alternatively, the arrangement of the light receiving optical system 12 may also be modified as necessary.

The embodiment of the invention may be changed or modified in various ways as necessary, as far as such changes and modifications do not depart from the scope of the claims of the invention hereinafter defined.

What is claimed is:

1. An information acquiring device for acquiring information on a target area using light, comprising:
a laser light source;
a diffractive optical element which is disposed in such a direction as to be away from an optical axis of the laser light source;
a photodetector which is disposed to face the diffractive optical element with respect to the optical axis; and
an optical path separating portion which guides laser light emitted from the laser light source to the diffractive optical element, and guides the laser light reflected on the diffractive optical element to the photodetector, wherein
the diffractive optical element irradiates the target area with the laser light having a predetermined pattern, and
the photodetector receives a part of the laser light diffracted and reflected on the diffractive optical element.

2. The information acquiring device according to claim 1, wherein
the optical path separating portion has a polarized beam splitter which reflects the laser light emitted from the laser light source, and a quarter wave plate which is disposed between the diffractive optical element and the polarized beam splitter.

3. The information acquiring device according to claim 1, wherein
the optical path separating portion has a non-polarized beam splitter which reflects a part of the laser light emitted from the laser light source, and which transmits a part thereof, and
the laser light emitted from the laser light source is reflected on the non-polarized beam splitter, and is directed to the diffractive optical element.

4. The information acquiring device according to claim 3, wherein
the non-polarized beam splitter is a half mirror.

5. The information acquiring device according to claim 1, further comprising:
a control portion which controls the laser light source, wherein
the control portion controls the laser light source to stop emitting the laser light, in the case where an output signal from the photodetector is out of a predetermined threshold range.

6. An object detecting device, comprising
an information acquiring device which acquires information on a target area using light,
the information acquiring device including:
a laser light source;
a diffractive optical element which is disposed in such a direction as to be away from an optical axis of the laser light source;
a photodetector which is disposed to face the diffractive optical element with respect to the optical axis; and
an optical path separating portion which guides laser light emitted from the laser light source to the diffractive optical element, and guides the laser light reflected on the diffractive optical element to the photodetector, wherein
the diffractive optical element irradiates the target area with the laser light having a predetermined pattern, and
the photodetector receives a part of the laser light diffracted and reflected on the diffractive optical element.

7. The object detecting device according to claim 6, wherein
the optical path separating portion has a polarized beam splitter which reflects the laser light emitted from the laser light source, and a quarter wave plate which is disposed between the diffractive optical element and the polarized beam splitter.

8. The object detecting device according to claim 6, wherein
the optical path separating portion has a non-polarized beam splitter which reflects a part of the laser light emitted from the laser light source, and which transmits a part thereof, and
the laser light emitted from the laser light source is reflected on the non-polarized beam splitter, and is directed to the diffractive optical element.

9. The object detecting device according to claim 8, wherein
the non-polarized beam splitter is a half mirror.

10. The object detecting device according to claim 6, further comprising:
a control portion which controls the laser light source, wherein
the control portion controls the laser light source to stop emitting the laser light, in the case where an output signal from the photodetector is out of a predetermined threshold range.
